(19) United States
(12) Patent Application Publication
(10) Pub. No.: US 2006/0209113 A1
(43) Pub. Date: Sep. 21, 2006

(54) Printing control device, printing control method, and media with printing control program recorded thereon

(75) Inventor: Kimito Katsuyama, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/369,921

(22) Filed: Mar. 8, 2006

(30) Foreign Application Priority Data
Mar. 8, 2005 (JP) 2005-063879

(51) Int. Cl. B41J 2/205

(52) U.S. Cl. 347/15

(57) ABSTRACT

When the disposition of dots is determined based on image data that indicates the recording density of each pixel, the following procedure is taken: disposition is determined with respect to one kind of dots or a combination of two or more kinds of dots that will have the greatest influence on graininess among N kinds (N is an integer not less than 2) of dots and the combinations of n kinds (n is an integer not less than 2 and not more than N) of dots; thereafter, disposition is determined with respect to the dots whose disposition has not been determined yet; and control is carried out so as to print an image based on the determined disposition of dots.

The entire disclosure of Japanese Patent Application No. 2005-63879, filed Mar. 8, 2005, is expressly incorporated by reference herein.

### BACKGROUND

1. Field of the Invention

The present invention relates to a printing control device, a printing control method, and media with a printing control program recorded thereon.

2. Related Art

To print an image with a printing device, a quantity of recording material to be recorded is determined with respect to each pixel; then, the recording material is recorded on printing media with a mechanism that records recording material on a pixel-by-pixel basis. JP-A-2000-108420 discloses the following printing method: a head is provided with two or more different kinds of ink, identical in hue and different in density; the head is capable of forming three or more kinds of dots, including two or more kinds of dots formed by varying the ink weight using at least one kind of ink, on printing media; using this head, a multiple-tone image is printed by the distribution of the dots. In cases where the dots that can be formed with the head are four or more kinds of dots in total formed using deep ink, high in density, and pale ink, low in density, with two or more levels of ink weight, this printing method takes the following measure: whether a dot formed with deep ink is on or off is determined in descending order of ink weight; and then whether a dot formed with pale ink is on or off is determined in descending order of ink weight.

Techniques in the past have been required to further improve graininess to cope with diversified situations. Even if the color material densities of dots are individually considered with respect to each of small, medium, and big dots when the disposition of dots is determined, the techniques in the past cannot control the graininess with respect to the entire small, medium, and big dots.

### SUMMARY

An advantage of some aspects of the invention is to improve the graininess of the entire dots when two or more kinds of dots, different in color material quantity per dot.

According to a first aspect of the invention, there is provided a printing control method for controlling a printing device capable of recording N kinds (N is an integer not less than 2) of dots, different in color material quantity per dot, the method comprising:
determining disposition of one kind of dots or a combination of two or more kinds of dots that will have the greatest influence on graininess, among the N kinds of dots and the combinations of n kinds (n is an integer not less than 2 and not more than N) of dots, and thereafter, determining disposition of the dots whose disposition has not been determined yet when the disposition of dots is determined based on image data that indicates the recording density of each pixel; and
carrying out control so as to print an image based on the determined disposition of dots.

According to a second aspect of the invention, there is provided a printing control device that controls a printing device capable of recording N kinds (N is an integer not less than 2) of dots different in color material quantity per dot, the printing control device comprising:

a halftone processing unit that, when disposition of dots is determined based on image data that indicates the recording density of each pixel, determines disposition of one kind of dots or a combination of two or more kinds of dots that will have the greatest influence on graininess, among the N kinds of dots and the combinations of n kinds (n is an integer not less than 2 and not more than N) of dots, and thereafter determines disposition of the dots whose disposition has not been determined yet; and

a printing control unit that carries out control so as to print an image based on the determined disposition of dots.

That is, first, disposition is determined with respect to one kind of dots or a combination of two or more kinds of dots that will have the greatest influence on graininess. Then, disposition is determined with respect to the dots whose disposition has not been determined yet by halftone processing. In cases where disposition is determined first with a kind of dots or a combination of dots that will have the greatest influence on graininess, the following advantage is brought: with respect to multiple pixels, it can be determined with a high degree of freedom whether a dot is to be disposed or not. As a result, with respect to a kind of dots or a combination of dots that will have the greatest influence on graininess, the dots can be so disposed that graininess is suppressed, and thus print operation is performed with reduced grainy appearance.

When N kinds of dots, different in color material quantity per dot, are prevented as much as possible from being recorded in overlapped positions, positions where some dot can be disposed are limited by disposing other dots. When dots cannot be recorded at the same pixel because of mechanism, positions where some dots can be disposed are limited by determining the disposition of other dots first. Consequently, the order in which the dispositions of dots are determined is important, and graininess can be suppressed by determining the disposition of a kind of dots or a combination of dots that will have the greatest influence on graininess. When the disposition of dots is determined, halftone processing is performed. In this processing, in general, the positions of dots are determined so that the dots are disposed dispersedly as much as possible (so that positional bias is reduced). Therefore, graininess can be suppressed by determining the order in which the disposition of dots is determined, as in the invention.

N kinds of dots, different in color material quantity per dot, can be obtained in various fashions. For example, the color material quantity per dot may be made different by varying the quantity of ink recorded as one dot. In cases where the quantity of ink per dot is substantially identical, the color material quantity per dot may be made different by varying the quantity of color material contained in a unit quantity of solvent. Or, it may be made different by combining both the measures mentioned above. Therefore, possible N kinds of dots, different in color material quantity per dot, include: N kinds of dots, different in size per dot; N kinds of dots, different in the color material density of ink; a combination of them; and the like.

N kinds of dots, different in size per dot, are favorable. This is because, when dots are of ink identical in the density of contained color material, the order of influence given onto graininess agrees with the order of dot size. However, dots of ink different in the density of contained color material are also acceptable. Size per dot is defined, for example, by ink weight per dot. Instead, it may be defined by ink volume per dot.

N kinds of dots, different in the color material density of ink, are favorable. This is because, when N kinds of dots are of ink different in the density of color material with the same hue and identical in size per dot, the order of influence given onto graininess agrees with the order of color material density. However, N kinds of dots of ink different in hue and identical in size per dot are also acceptable, and N kinds of dots different in size per dot are also acceptable. When, at least color material and solvent are contained in ink, for example, the color material density of ink is defined by the weight of color material contained in a unit weight of ink. Instead, it may be defined by the weight of color material contained in a unit volume of ink or by the volume of color material contained in a unit weight of ink.

The above-mentioned recording density of dots is defined, for example, by the recording rate of dots recorded per unit area. Specifically, it is defined by the ratio Nd/Np of the number of dots Nd recorded in a print range having a predetermined number Np (Np is an integer not less than 2) of pixels to the predetermined number Np.

The above-mentioned recording density of each pixel that is represented by image data is defined, for example, by a value corresponding to the recording rate of dots recorded per unit area. For this value, for example, a gradation value in multiple tone, such as 256 levels of gray, can be used.

In cases where any of N kinds of dots is recorded at some pixel, the above-mentioned image data may be data in which a gradation value corresponding to the recording rate of each of N kinds of dots is defined with respect to each pixel. Or, it may be data in which a gradation value corresponding to the recording rate of dots is individually defined with respect to each of N kinds and a gradation value is defined for each pixel.

The following construction may be adopted: the printing control device is provided with an image data acquisition unit for acquiring the above image data, and the halftone processing unit determines the disposition of dots based on the image data acquired by the image data acquisition unit.

The halftone processing unit determines whether to record N kinds of dots or not with respect to each pixel and thereby determines the disposition of dots. At this time, it specifies the order in which the dispositions of dots are determined. In this operation, it specifies the order in which the dispositions are determined with respect to not only the dispositions of individual dots but also the dispositions of combinations of dots. The disposition of a combination of n kinds of dots, cited here, refers to specifying the disposition of dots with respect to n kinds of dots at least any one of which should be recorded.

To suppress graininess with n kinds of dots involved, the n kinds of the dots should be disposed dispersedly as much as possible. In the invention, to accomplish this, evaluation is made beforehand for the influence given onto graininess with respect to not only individual dots but also combinations of n kinds of dots. As a result, it can be grasped which has the greatest influence on graininess, any one kind of individual dots or a combination of n kinds of dots. Therefore, disposition is determined first with respect to what will have the greatest influence. With respect to dots whose disposition is not determined at this time, the degree of freedom in selecting their positions is reduced. However, graininess can be suppressed as a whole since dots can be so disposed that graininess is suppressed with a kind of dots or a combination of dots that will have the greatest influence on graininess.

Graininess can be quantitatively evaluated. (Refer to the paper written by Makoto Fujino on pages 291-294 of the collected papers for Japan Hardcopy '99.) One kind of dots or a combination of dots that will have the greatest influence on graininess can be defined by actually printing patches for evaluation with individual dots and combinations of any dots. That is, the following can be easily grasped by printing multiple patches for evaluation with the disposition of dots varied and evaluating graininess: a kind of dots or a combination of dots that will make graininess prone to vary most with respect to each disposition of dots.

The printing control unit only has to be capable of printing an image based on the disposition of dots determined by the halftone processing unit. Therefore, various constructions can be adopted for the printing control unit. Some examples will be taken. In cases where the printing control device is a computer separated from a printing device, data for performing print operation based on image data obtained as the result of halftone processing is outputted to the printing device. In cases where the printing control device is integrated with a printing device, a mechanism for performing print operation based on image data obtained as the result of halftone processing is controlled.

The above halftone processing unit determines first the disposition of one kind of dots or a combination of two or more kinds of dots that will have the greatest influence on graininess. Thus, the disposition of dots can be determined so as to remarkably suppress graininess. However, to reduce graininess as much as possible, it is desirable to determine dispositions in descending order of the magnitude of influence on graininess. That is, the disposition of dots is determined as follows: disposition is determined first with respect to one kind of dots or a combination of two or more kinds of dots that will have the greatest influence on graininess; then, disposition is determined with respect to one kind of dots or a combination of two or more kinds of dots that will have the second greatest influence. As a result, graininess can be minimized using the disposition of dots obtained as the result of halftone processing.

In the above description, the degree of influence on graininess is determined by quantitatively evaluating graininess. Instead, the degree of influence on graininess may be determined beforehand by a difference in color material quantity between combined kinds of dots from among the N kinds of dots. For example, the degree of influence on graininess may be evaluated by a difference in size (ink weight, or the like) between combined kinds of dots. Or, the degree of influence on graininess may be evaluated by a difference in the color material density of ink between combined kinds of dots. In cases where dots are large in size or dots are large in color material quantity, as in cases where the color material of ink of dots is dense, these dots are prone to be conspicuous, and this can impair graininess. When N different kinds of dots are compared with respect to color material quantity and a different in color material quantity is small, a difference in the degree of influence on graininess between them is reduced.

Therefore, the degree of influence on graininess can be evaluated by evaluating a difference in color material quantity. For example, in cases where a difference in color material quantity between multiple dots is within a predetermined range, the following takes place: graininess can be more easily suppressed by determining the disposition of combinations of dots than by determining the disposition of each kind of dots. Consequently, the order of processing can be easily determined by taking the following procedure: differences in color material quantity and the degrees of influence on graininess are brought beforehand into correspondence with each other; and then the order of processing performed at the halftone processing unit is determined based on the differences.

After determining the disposition of a combination of n kinds of dots, the halftone processing unit determines the disposition of each of n kinds of dots. In this case, the dispositions determined with respect to n kinds of dots are taken as temporary, and the dispositions of n kinds of dots are determined with only the temporary dispositions taken as the candidates of positions. More specific description will be given. The disposition determined with respect to a combination of n kinds of dots is positions where any of the n kinds of dots should be recorded. Therefore, the dispositions of dots whose disposition has not determined yet are determined within the above limited disposition.

Halftone processing is performed, for example, on the following assumption: after disposition is temporarily determined with respect to a combination of n kinds of dots, n−1 kinds of dots can be recorded only in the positions temporarily determined as mentioned above. After disposition is determined with respect to n−1 kinds of dots, the positions that were not taken as the positions where the n−1 kinds of dots are recorded and were temporarily determined as mentioned above are taken as the positions where the remaining one kind of dots should be recorded.

According to a third aspect of the invention, there is provided a printing control method for controlling a printing device capable of recording N kinds (N is an integer not less than 2) of dots different in color material quantity per dot, the method comprising:
determining disposition of a combination of two or more kinds of dots in a lump, and thereafter, determining disposition of dots whose disposition has not been determined yet when the disposition of dots is determined based on image data that indicates the recording density of each pixel; and
carrying out control so as to print an image based on the determined disposition of dots.

According to a fourth aspect of the invention, there is provided a printing control device that controls a printing device capable of recording N kinds (N is an integer not less than 2) of dots different in color material quantity per dot, the printing control device comprising:
a halftone processing unit that, when disposition of dots is determined based on image data that indicates the recording density of each pixel, determines disposition of a combination of two or more kinds of dots in a lump, and thereafter determines disposition of the dots whose disposition has not been determined yet; and
a printing control unit that carries out control so as to print an image based on the determined disposition of dots.

More specific description will be given. When the disposition of N kinds of dots is determined, the disposition of a combination of two or more kinds of dots is determined in a lump, and then disposition is determined with respect to each of the two or more kinds of dots. Thus, the combination of two or more kinds of dots can be disposed dispersedly as much as possible. Therefore, the halftone processing unit determines the disposition of combination before individually determining the dispositions of at least two or more kinds of dots, and it can thereby perform halftone processing in which graininess is enhanced.

The various devices mentioned above have various embodiments, such as an embodiment in which they are incorporated in some device and implemented together with any other methods. For example, the invention can be embodied as a printing system including a printing control device and a printing device. There are cases where a control program is executed in the above devices. Therefore, the invention can be embodied as a program, computer-readable recording media with such a program recorded thereon, or a program product. Every one of these embodiments has the same action and effect.

### BRIEF DESCRIPTION OF THE DRAWINGS

FIG. 1 is a block diagram illustrating the general configuration of a printing control device.

FIG. 2 is a flowchart illustrating printing control processing.

FIG. 3 is a drawing illustrating an example of a small/medium/big allocation table.

FIG. 4 is a flowchart illustrating an example of error diffusion processing for small, medium, and big dots.

FIG. 5 is an explanatory drawing illustrating an example of error diffusion processing.

FIG. 6 is a flowchart illustrating an example of error diffusion processing for small, medium, and big dots.

FIG. 7 is an explanatory drawing illustrating an example of error diffusion processing.

FIG. 8 is a flowchart illustrating an example of error diffusion processing for small, medium, and big dots.

FIG. 9 is an explanatory drawing illustrating an example of error diffusion processing.

### DESCRIPTION OF EXEMPLARY EMBODIMENTS

Description will be given to embodiments of the invention in the order listed below:

(1) Configuration of Printing Control Device:

(2) Printing Control Processing:

(2-1) Error Diffusion Processing for Small, Medium, and Big Dots:

(3) Other Embodiments:

(1) Configuration of Printing Control Device:

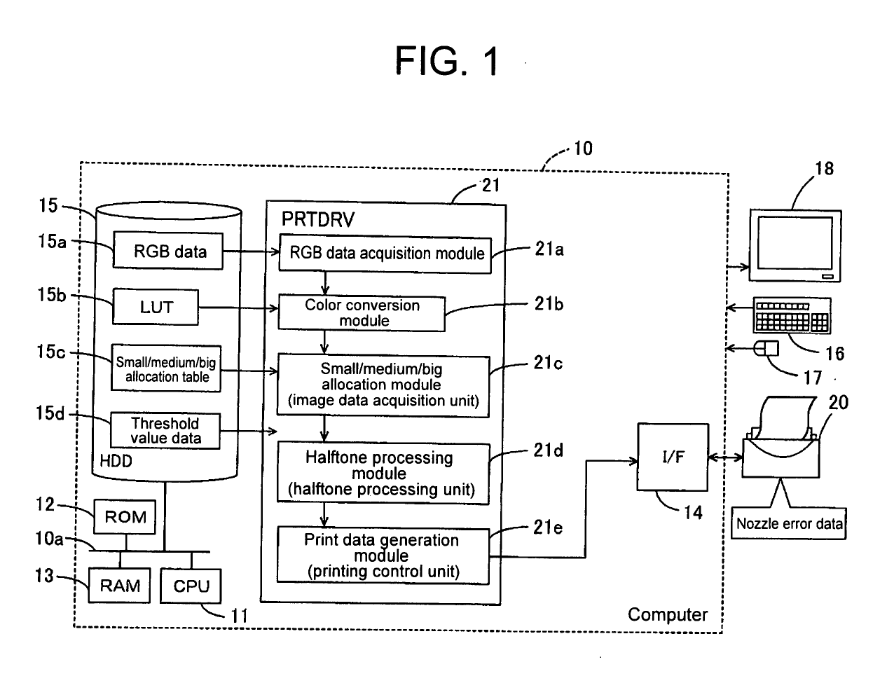

FIG. 1 illustrates the general configuration of a printing control device in an embodiment of the invention. In this embodiment, a printing control device is implemented by part of the functions of a computer 10. The computer 10 has CPU 11 that serves as the nerve center of computation. The CPU 11 controls the entire computer 10 through a system bus 10a. The system bus 10a is connected with ROM 12, RAM 13, an interface (I/F) 14 and a hard disk drive (HDD) 15, a CRT I/F and an input device I/F that are not shown in the figure, and the like.

In the hard disk drive 15, there are stored programs, such as operating system (OS), as software. Such programs as printer driver (PRTDRV) 21 can be installed and stored there as required. When executed, these pieces of software are transferred to the RAM 13 by the CPU 11 as appropriate. The CPU 11 accesses the RAM 13 as a temporal work area as appropriate, and executes various programs under the control of the OS.

The input device I/F is connected with a keyboard 16 and a mouse 17 as input devices for operation. The CRT I/F is connected with a display 18 for screen display. Therefore, the computer 10 is capable of accepting what is instructed or the like through the operation of the keyboard 16 or the mouse 17, and displaying varied information on the display 18. The I/F 14 is connected with a printer 20, which is capable of printing images based on data outputted from the computer 10. A variety of I/Fs can be adopted for the I/F 14. Such I/Fs include serial I/Fs such as USB I/F, parallel I/Fs, I/Fs in accordance with the SCSI specifications, and the like.

The printer 20 used in this embodiment is an ink jet printer, but it may be a laser printer. Diversified printers can be adopted. In any case, the computer 10 generates print data that can be interpreted by the printer 20 and outputs it through the I/F 14. The printer 20 prints an image by recording ink (recording material) with respect to each of the pixels that constitute the image based on the print data.

The printer 20 in this embodiment is provided with a carriage in which multiple nozzle trains are formed with respect to each color. The printer reciprocatingly moves the carriage in the direction perpendicular to the direction of printing media feed, and thereby performs main scanning. In addition, it feeds printing media and thereby performs sub-scanning. Piezo elements are provided in the nozzles of the carriage, and the quantities of ink discharged from the openings of the nozzles can be varied by voltage applied to the piezo elements. This embodiment is so constructed that ink can be discharged at three levels. In this specification, ink dots are designated as small dot, medium dot, and big dot in ascending order of ink weight. These dots are collectively designated as small, medium, and big dots. The printer 20 is so constructed that the following is implemented: to form a pixel, only any of small, medium, and big dots is discharged from one nozzle, and multiple dots are prevented from being discharged from one nozzle to form one pixel. A printer that forms four or more different kinds of dots may be used.

According to the foregoing, the printer 20 is a printing device so designed that the above-mentioned N kinds of dots of ink identical in the density of contained color material and different from each other in size per dot are formed on printing media.

The printing media include printing media of coated paper, including glossy paper (e.g. photo paper), and printing media of non-coated paper, including plain paper and recycled paper.

The printer 20 can be loaded with inks in C, M, Y, K, lc, and lm (cyan, magenta, yellow, black, light cyan, and light magenta) colors, and discharges ink droplets in the respective colors from nozzle trains provided for the respective colors. Needless to add, any other type of printers may be adopted for the printer 20. Such printers includes: printers that also use inks in dark yellow (deep color of the above yellow), red, violet, gray (pale color of the above black), and light gray (pale color of the above gray), uncolored ink (glossy appearance improving ink), and the like; printers that do not use any of C, M, Y, K, lc, and lm inks; various types of ink jet printers, such as bubble-type printers so designed that bubbles are produced in ink passages to discharge ink; laser printers that use toner ink; and the like. Each ink in this embodiment is ink prepared by mixing color material composed of fine pigment in aqueous solvent. Instead, the following inks may be used: ink prepared by mixing in coloring material (a kind of color material in the invention) composed of dye; and ink prepared by mixing color material in lipid solvent.

Light cyan is a pale color of cyan, and cyan ink and light cyan ink are inks different from each other in the density of color material contained per unit quantity with the same hue. It is preferable that cyan ink and light cyan ink should be inks containing the same color material and different from each other in the density of that color material. Therefore, cyan ink and light cyan ink are different from each other in color material quantity per dot. Light magenta is a pale color of magenta, and magenta ink and light magenta ink are inks different from each other in the density of color material contained per unit quantity with the same hue. It is preferable that magenta ink and light magenta ink should be inks containing the same color material and different from each other in the density of that color material. Therefore, magenta ink and light magenta ink are different from each other in color material quantity per dot. That is, the printer 20 is capable of discharging inks substantially identical in hue but different in color material density. Needless to add, this printer is an example, and may be so constructed that it is capable of forming deep and pale dots with respect to any other color, for example, black.

According to the foregoing, this printer 20 is a printing device capable of forming N kinds of dots of ink different in the density of color material with the same hue and different from each other in size per dot on printing media.

In this embodiment, a printing control device is constructed of a computer 10, but other constructions may be adopted. Some examples will be taken. The printing control device may be so constructed that the printing control processing of the invention can be performed in the environment in which programs installed in the printer 20 are executed. Thus, printing control processing is performed by acquiring data from a digital camera or the like directly connected to the printer 20. With the same construction, needless to add, printing control processing may be performed at a digital camera. The printing control processing of the invention may be performed by dispersed processing. The printing control processing of the invention may be performed at a so-called all-in-ones in which a scanner for capturing images and a printer for printing images are integrated with each other.

(2) Printing Control Processing:

The printer driver (PRTDRV) 21 causes the computer to carry out the following function: a function of performing predetermined processing with respect to an image for which an instruction to print has been given from an application program, not shown in the figure, and thereby performing print operation. The PRTDRV 21 has an RGB data acquisition module 21a, a color conversion module 21b, a small/medium/big allocation module 21c, a halftone processing module 21d, and a print data generation module 21e for performing print operation. When the above instruction to print is given, the PRTDRV 21 is driven, and RGB data 15a is processed by the individual modules and print data is generated. The generated print data is outputted to the printer 20 through the I/F 14, and the printer 20 performs print operation based on that print data.

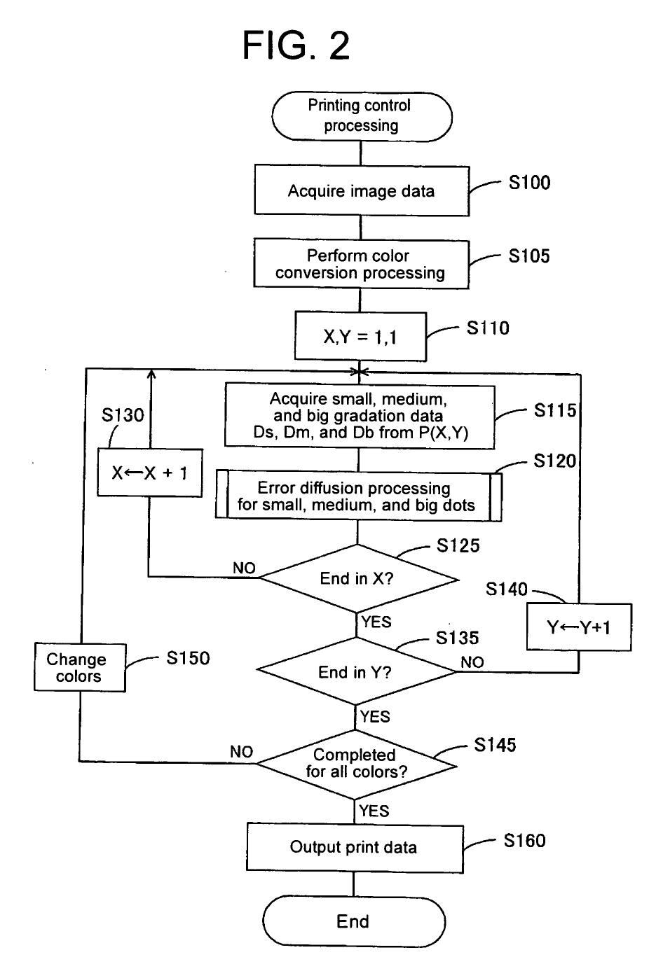

FIG. 2 is a flowchart illustrating this printing control processing. When the above instruction to print is given, the computer 10 acquires RGB data 15a that indicates an image for which the instruction to print has been given through the RGB data acquisition module 21a (Step S100). In a case where the number of pixels in the RGB data 15a is too large or too small at this time, resolution conversion processing is performed as appropriate to ensure pixels required for print operation. In this embodiment, this RGB data 15a is data in which the color of each pixel is defined by representing the R, G, and B (red, green, and blue) color components with a gradation. Each color is represented with a 256-step gradation. In the description of this embodiment, RGB data 15a in which colors are represented by RGB color components is taken as an example. However, other varied data, including JPEG data using the YCbCr color system and data using the CMYK color system, can also be adopted.

Next, the computer 10 converts the color system in which the color of each pixel is indicated through the color conversion module 21b (Step S105). More specific description will be given. The computer refers to LUTs (color conversion tables) 15b, stored beforehand in the HDD 15, as appropriate. It then converts data in which colors are represented in the RGB color system into CMYKlclm data in which colors are represented in the CMYKlclm color system. The data obtained as the result of color conversion is data in which the color of each pixel is defined by representing colors with a gradation using colors of inks used in the printer 20 as color components. The gradation values in this CMYKlclm data correspond to the recording densities of the individual colors. A higher gradation value represents a higher density. Therefore, CMYKlclm data is image data in which the recording density of each pixel is indicated.

The number of gradation steps the printer 20 in this embodiment can represent at each pixel is four (small, medium, and big dots and no dot). Therefore, the number of gradation steps in CMYKlclm data does not agree with the number of gradation steps in which ink is recorded at each pixel by the printer 20. Consequently, whether a dot is on or off at each pixel with respect to the printer 20 is determined from CMYKlclm data (when ink is recorded, that is designated as on, and when ink is not recorded, that is designated as off). To do this, the processing to convert the number of gradation steps is performed by the small/medium/big allocation module 21c and the halftone processing module 21d.

This processing is performed with respect to each pixel in CMYKlclm data. To perform processing with respect to each pixel, the computer 10 initially sets the coordinate variables X and Y that indicate the position of the relevant pixel to 1, respectively (Step S110). In the HDD 15, there are recorded small/medium/big allocation tables 15c in which the individual gradation values for C, M, Y, K, lc, and lm are in correspondence with gradation values that indicate the recording quantities of small, medium, and big dots. The computer 10 refers to the small/medium/big allocation tables 15c, and performs conversion processing through the small/medium/big allocation module. In this processing, the individual gradation values for C, M, K, Y, lc, and lm are converted into the gradation values of small, medium, and big dots that represent the recording rate of each pixel with respect to each of dot kinds (recording rate data) (Step S115).

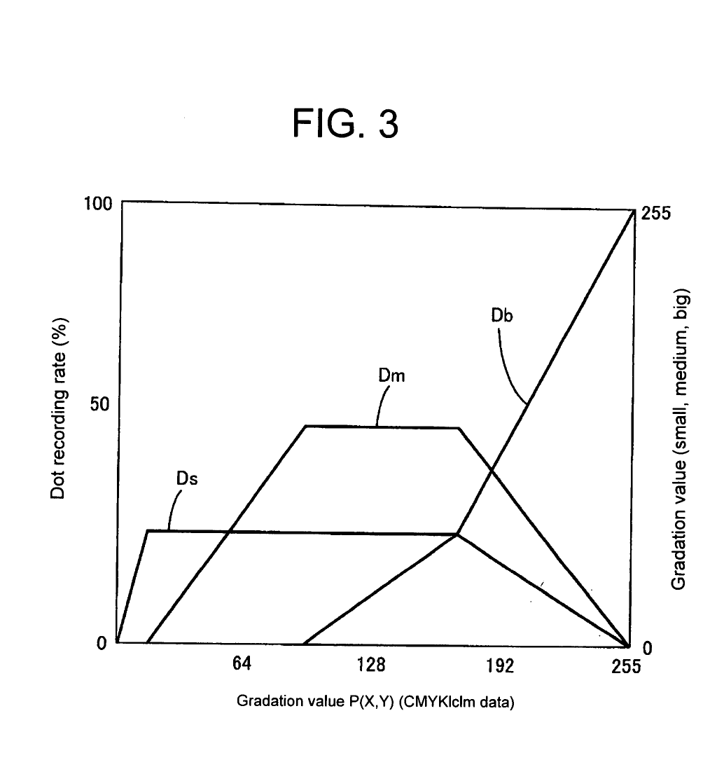

FIG. 3 is a drawing illustrating an example of the small/medium/big allocation table 15c. This drawing shows the small/medium/big allocation table for some color, and the horizontal axis represents the gradation value for C, M, Y, K, lc, and lm and the vertical axis represents the gradation value and recording rate for small, medium, and big dots. (The recording rate refers to a ratio of the number of dots recorded to the maximum number of dots that can be recorded per unit area.) Thus, in the small/medium/big allocation tables 15c, data for computing the gradation values of small, medium, and big dots from gradation values in CMYKlclm data only has to be defined. The small/medium/big allocation module 21c converts CMYKlclm data into recording rate data in which gradation values are defined on a dot kind-by-dot kind basis.

In this specification, P(X,Y) is taken as gradation values in CMYKlclm data, and Ds, Dm, and Db are respectively taken as the gradation values of small, medium, and big dots in recording rate data. The gradation values of small, medium, and big dots only have to indicate the recording quantities and used amounts of inks for small, medium, and big dots. These gradation values can be constructed in various manners. An example will be taken. The state in which no dot is recorded is represented by a gradation value of 0, and the state in which a small, medium, or big dot is recorded to the maximum is represented by a gradation value of 255; the gradation values between 0 and 255 and used amounts are brought into linear correspondence with each other. The printer 20 is so constructed that only any one kind of small, medium, and big dots can be set to on or off at each pixel. Therefore, dots cannot be recorded at each pixel in the printer 20 in accordance with the number of gradation steps (256) of small, medium, and big dots. However, since ink is recorded per unit area according to a certain gradation value, the ratio of the number of pixels at which a dot is on to the number of all the pixels in that area corresponds to the gradation value of a small, medium, or big dot. Therefore, the following can be said: the gradation values of small, medium, and big dots correspond to the recording rates of small, medium, and big dots.

The halftone processing module 21d is a module that determines whether a small, medium, or big dot should be set to on or off at each pixel. The computer 10 compares threshold value data 15d with gradation values of small, medium, and big dots, and performs error diffusion processing. In this processing, the computer determines whether a dot is formed or not with respect to each pixel according to recording rate data that indicates the recording rates of dots. The computer diffuses (adds) errors, produced at this time, into peripheral pixels that have not been subjected to conversion. While doing this, the computer generates halftone data that indicates whether a dot is formed or not with respect to each pixel (Step S120). At this time, the computer determines whether a dot is on or off with priority given to a kind of dots or a combination of dots that will have great influence on graininess. Thus, the computer finally determines whether small, medium, and big dots are on or off. This processing will be described in detail later. Processing to determine whether a combination of dots is on or off, cited here, refers to processing to determine that any of multiple dots is on. The threshold value data 15d is threshold values to be compared with gradation values of small, medium, and big dots. It only has to be determined at least before the comparison is made. In this embodiment, Step S115 corresponds to processing performed by the image data acquisition unit, and Step S120 corresponds to processing performed by the halftone processing unit.

When error diffusion processing is completed with respect to small, medium, and big dots, the following operation is performed: based on the coordinate variable X, it is determined whether the processing has been completed to the end in the X direction (the maximum value in the X direction in CMYKlclm data) or not (Step S125). When it is not determined that the processing has been completed to the end in the X direction, the coordinate variable X is incremented (Step S130), and the processing of Step S115 and the following step is repeated. When it is determined at Step S125 that the processing has been completed to the end in the X direction, it is determined whether the processing has been completed to the end in the Y direction (the maximum value in the Y direction in CMYKlclm data) or not (Step S135).

When it is not determined that the processing has been completed to the end in the Y direction, again, the coordinate variable Y is incremented (Step S140), and the processing of Step S115 and the following steps is repeated. When it is determined at Step S135 that the processing has been completed to the end in the Y direction, the error diffusion processing is completed with respect to all the pixels in the relevant color. Therefore, it is determined whether the error diffusion processing has been completed for all the C, M, Y, K, lc, and lm colors or not (Step S145). When it is not determined at Step S145 that the error diffusion processing has been completed for all the colors, the color for which the processing should be performed is changed to a color for which the processing has not been performed (Step S150), and the processing of Step S115 and the following steps is repeated.

When it is determined at Step S145 that the error diffusion processing has been completed for all the colors, print operation is performed. In this operation, the print data generation module 21e acquires data for use in one time of main scanning from data obtained as the result of error diffusion processing and outputs it to the printer 20 one by one (Step S160). The printer 20 forms an image on printing media based on this data. In this embodiment, Step S160 corresponds to the processing performed by the printing control unit.

The above-mentioned error diffusion processing is performed while whether a dot is on or off is determined with priority given to a kind of dots or a combination of dots that will have great influence on graininess. Therefore, the disposition of a kind of dots or a combination of dots that will have great influence on graininess can be determined without being influenced by other dots. As a result, grainy appearance which print results will have can be reduced.

(2-1) Error Diffusion Processing for Small, Medium, and Big Dots:

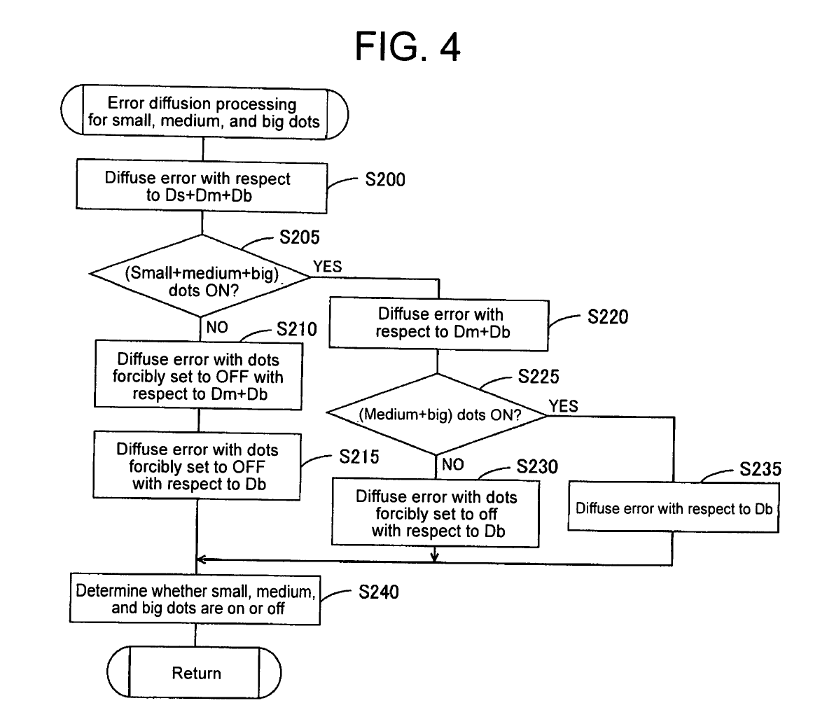

FIG. 4 is a flowchart illustrating an example in which error diffusion processing for small, medium, and big dots is carried out on a pixel of interest in a position (X,Y) on an image represented with CMYKlclm data. In the invention, the order in which whether a dot is on or off should be determined is determined based on the degree of influence on graininess. More specific description will be given. Even when the number of dots that are on per unit area is identical, graininess varies depending on the disposition of dots. Therefore, dots are disposed so as to minimize grainy appearance. To accomplish this, this embodiment takes the following measure: attention is focused on a difference in the weight of discharged ink (color material quantity) between small, medium, and big dots; when a difference in discharged weight between multiple dots is equal to or less than a predetermined difference, disposition is determined with priority given to a combination of those dots; when a difference in discharged weight is equal to or greater than the predetermined difference and an individual kind of dots are conspicuous, disposition is determined with priority given to the conspicuous kind of dots.

More specific description will be given. When small, medium, and big dots are individually compared, big dots are most conspicuous, and thus they have great influence on graininess. When a difference in discharged weight (color material quantity) between big dots and medium dots is small and a difference in discharged weight between big dots and small dots is also small, the following takes place: the overall grainy appearance can be reduced more by highly dispersedly disposing a combination of small, medium, and big dots than by determining the disposition with which only big dots are most dispersed (grainy appearance is reduced) . Consequently, the following measure is taken: the influence on graininess is evaluated with respect to cases where only small, medium, or big dots are disposed and combinations of small, medium, and big dots (combinations of two and three kinds of them) are disposed; then, disposition is determined with priority given to the most conspicuous kind or combination of dots. Graininess can be quantitatively evaluated by the above-mentioned technique or the like. (Refer to the paper written by Makoto Fujino on pages 291-294 of the collected papers for Japan Hardcopy '99.) Or, the following construction may be adopted: letting the discharged weight of big dots be Wb, the discharged weight of medium dots be Wm, the discharged weight of small dots be Ws, threshold values for discharged weight be TWbm and TWbs, that a difference in discharged weight between big dots and medium dots is defined by Wb−Wm≦TWbm or Wb−Wm<Wm; or that a difference in discharged weight between big dots and small dots is defined by Wb−Ws≦TWbs or Wb−Ws<Ws. Alternatively, the following construction may be adopted: patches (color chips) with the same recording density are printed on printing media with respect to each kind of dots, and the colors of these patches are measured with a calorimeter; the same definition as mentioned above is made based on the thus obtained color measurement values, such as lightness.

FIG. 4 illustrates error diffusion processing performed in the following case: a difference Wb−Ws in discharged weight between small and big dots is equal to or less than the predetermined difference TWbs; the combination of small, medium, and big dots has the greatest influence on graininess, and the combination of medium and big dots has the next greatest influence on graininess, followed by big dots. To perform this processing, in this embodiment, the following data are prepared when error diffusion is carried out: the gradation value data of total recording rate data that is for determining the disposition of dots with respect to the combination of small, medium, and big dots, and indicates the total of the recording rates of the individual kinds of dots that constitute that combination with respect to each pixel; the gradation value data of total recording rate data that is for determining the disposition of dots with respect to the combination of medium and big dots and indicates the total of the recording rates of the individual kinds of dots that constitute that combination with respect to each pixel; and the gradation value data of recording rate data that is for determining the disposition of big dots and indicates the recording rate of big dots with respect to each pixel.

In this embodiment, these data are respectively defined as follows: the gradation value data of total recording rate data for determining the disposition of dots with respect to the combination of small, medium, and big dots is the sum of the gradation values of small, medium, and big dots; the gradation value data of total recording rate data for determining the disposition of dots with respect to the combination of medium and big dots is the sum of the gradation values of medium and big dots; and the gradation value data of recording rate data for determining the disposition of big dots is the gradation value of big dots. In the processing illustrated in FIG. 4, first, error diffusion processing is performed with respect to the sum of the gradation values of small, medium, and big dots. This is done for determining the disposition of dots with respect to the combination of small, medium, and big dots (Step S200).

This error diffusion processing is halftone processing in which the following is carried out: whether a dot is formed or not is determined on a pixel-by-pixel basis according to the gradation value data of the recording rate data or the total recording rate data; errors produced at this time are diffused into peripheral pixels that have not been subjected to conversion; while this is being done, halftone data that indicates whether a dot is formed or not on a pixel-by-pixel basis is generated. That is, this is processing in which the gradation value of a pixel of interest and a predetermined threshold value are compared with each other to determine whether a dot is on or off. Any error in gradational representation produced by setting a dot to on or off at this time is diffused into pixels peripheral to the pixel of interest for which pixels determination has not been made, and the result of diffusion is stored. When whether a dot is on or off is determined with respect to a pixel for which determination has not been made, it is determined so that any error diffused from peripheral pixels will be eliminated.

The number of pixels into which an error is diffused need not be one, and an error may be diffused into multiple pixels. Threshold values only have to be determined at least before error diffusion is carried out, and various techniques can be adopted. For simplicity, description will be given here on the assumption that a threshold value Th is determined beforehand; and the pixel into which an error is diffused at the coordinate variable X is the pixel at the coordinate variable X+1. That is, when error diffusion is carried out, the right-hand side is substituted for the left-hand side, as expressed by Expression (1) below.
D(X+1, Y)=D(X+1, Y)+(Th−D(X, Y)) (1)
where, D is a gradation value to be compared with the threshold value. As a rule, determination is made as follows: when the error (Th−D(X, Y)) between a threshold value and a gradation value is positive, it is determined that a dot is on; when the error is negative, it is determined that a dot is off.

In the invention, however, whether a dot is on or off is determined in sequence with respect to combinations of multiple kinds of dots or individual kinds of dots, as described later. Therefore, there are cases where whether a dot is on or off is forcibly determined regardless of the sign of (Th−D(X, Y)). This is in order that, when whether a dot is on or off is determined in each stage, the determination will be matched with dots for which on/off has been already determined. Detailed description will be given later.

In cases where whether small, medium, and big dots are on or off is determined on a dot-by-dot basis, any of the gradation values Ds, Dm, Db for small, medium, and big dots can be adopted as the above-mentioned D. In cases where whether a dot is on or off is determined with respect to combinations of small, medium, and big dots, the sum of the gradation values Ds, Dm, and Db is adopted as the gradation value D in total recording rate data. More specific description will be given. The gradation values Ds, Dm, and Db respectively indicate the ratio of the number of dots recorded to the maximum number of dots that can be recorded per unit area with respect to each of small, medium, and big dots. Therefore, the sum of the gradation values corresponds to the ratio of the number of pixels at which any of small, medium, and big dots is on to the maximum number of dots that can be recorded per unit area. Therefore, adoption of Ds+Dm+Db as D in Expression (1) above makes it possible to determine the disposition of any kinds of small, medium, and big dots that are on.

At Step S200, processing is performed. This processing is performed as follows: whether a dot is formed or not is determined with respect to Ds+Dm+Db of the pixel of interest; any error produced at this time is diffused into peripheral pixels that have not been subjected to conversion; while this is being done, halftone data that indicates whether dots are formed or not is generated. Thereafter, error diffusion is further carried out with respect to a dot of the coordinate variables X and Y to determine the disposition of small, medium, and big dots with respect to the dots that are set to on as the result of the above error diffusion. For this purpose, it is determined whether a dot has been set to on as the result of the error diffusion carried out at Step S200 with respect to the combination of small, medium, and big dots (Step S205). When it is not determined at Step S205 that a dot has been set to on with respect to the combination of small, medium, and big dots, none of small, medium, and big dots is disposed at the pixel corresponding to that dot.

Thus, halftone processing based on the error diffusion method is performed with respect to the combination of three kinds of dots, including the biggest dots, and the disposition of the individual kinds of dots is temporarily determined.

Next, error diffusion processing is performed. This processing is performed as follows: the sum (Dm+Db) of the gradation values of medium and big dots, which is gradation value data for determining the disposition of dots with respect to the combination of medium and big dots, is taken as D in Expression (1) above; any error produced with respect to Dm+Db of the pixel of interest is diffused into peripheral pixels that have not been subjected to conversion; while this is being done, halftone data that indicates whether dots are formed or not is generated (Step S210). However, the following measure is taken at this time: the error diffusion with respect to Dm+Db is error diffusion for determining the disposition of either kind of medium and big dots that are on. At Step S200, it was determined that the dot of the coordinate variables X and Y was off. Therefore, the dots are forcibly set to off. In the second term of Expression (1), processing is performed to add the absolute value of the error (Th−D(X, Y)) to D(X+1, Y).

Subsequently, error diffusion processing is performed. This processing is performed as follows: Db that is a gradation value for determining the disposition of big dots is taken as D in Expression (1) above; any error produced with respect to Db of the pixel of interest is diffused into peripheral pixels that have not been subjected to conversion; while this is being done, halftone data that indicates whether dots are formed or not is generated (Step S215). The dots are forcibly set to off here again. In the second term of Expression (1), processing is performed to add the absolute value of the error (Th−D(X, Y)) to D(X+1, Y).

When it is determined at Step S205 that a dot has been set to on with respect to the combination of small, medium, and big dots, error diffusion processing is performed. This error diffusion processing is performed as follows: the sum Dm+Db of the gradation values of medium and big dots is taken as D in Expression (1) above; whether a dot is formed or not is determined with respect to Dm+Db of the pixel of interest; any error produced at this time is diffused into peripheral pixels that have not been subjected to conversion; while this is being done, halftone data that indicates whether dots are formed or not is generated (Step S220). At this time, determination is made as follows: when the error (Th−D(X, Y)) is positive, it is determined that either a medium dot or a big dot is off; when the error is negative, it is determined that either a medium dot or a big dot is on.

Further, error diffusion is carried out to determine the disposition of big dots with respect to the dots that are set to on as the result of the above error diffusion. For this purpose, it is determined whether a dot has been set to on as the result of the error diffusion carried out at Step S220 with respect to the combination of medium and big dots (Step S225). When it is not determined at Step S225 that a dot has been set to on with respect to the combination of medium and big dots, neither a medium dot nor a big dot is disposed at the pixel corresponding to that dot. Therefore, the dots are forcibly set to off, and error diffusion processing is performed. This error diffusion processing is performed as follows: Db that is a gradation value for determining the disposition of big dots is taken as D in Expression (1) above; any error produced with respect to Db of the pixel of interest is diffused into peripheral pixels that have not been subjected to conversion; while this is being done, halftone data that indicates whether dots are formed or not is generated. Then the absolute value of the error (Th−D(X, Y)) is added to D(X+1, Y) (Step S230).

When it is determined at Step S225 that a dot has been set to on with respect to the combination of medium and big dots, error diffusion processing is further performed. This error diffusion processing is performed as follows: Db that is a gradation value for determining the disposition of big dots is taken as D in Expression (1); whether a dot is formed or not is determined with respect to Db of the pixel of interest; any error produced at this time is diffused into peripheral pixels that have not been subjected to conversion; while this is being done, halftone data that indicates whether dots are formed or not is generated (Step S235). At this time, determination is made as follows: when the error (Th−D(X, Y)) is positive, it is determined that a big dot is off; when the error is negative, it is determined that a big dot is on. Since the disposition of big dots is determined as the result of the above processing, whether small, medium, and big dots are on or off is determined based on this disposition (Step S240).

More specific description will be given. Only any one of small, medium, and big dots can be recorded at one pixel. Therefore, whether a dot is on or off is determined with respect to each pixel based on on/off of the dots determined through the error diffusion processing. In cases where it is determined at Step S235 that a big dot is on, it is determined that a big dot is on with respect to the pixel corresponding to that dot. In cases where a big dot is off and it is determined at Step S220 that either a medium dot or a big dot is on, it is determined that a medium dot is on. When both a medium dot and a big dot are off at a pixel with respect to which it is determined that any of small, medium, and big dots is on, it is determined that a small dot is on with respect to this pixel. In the other cases than the foregoing, every kind of dot is off.

Thus, halftone processing based on the error diffusion method is performed with respect to dots whose disposition has not been determined and which constitute the combination of three kinds of dots, including the biggest dots. As a result, the disposition of the individual kinds of dots is determined.

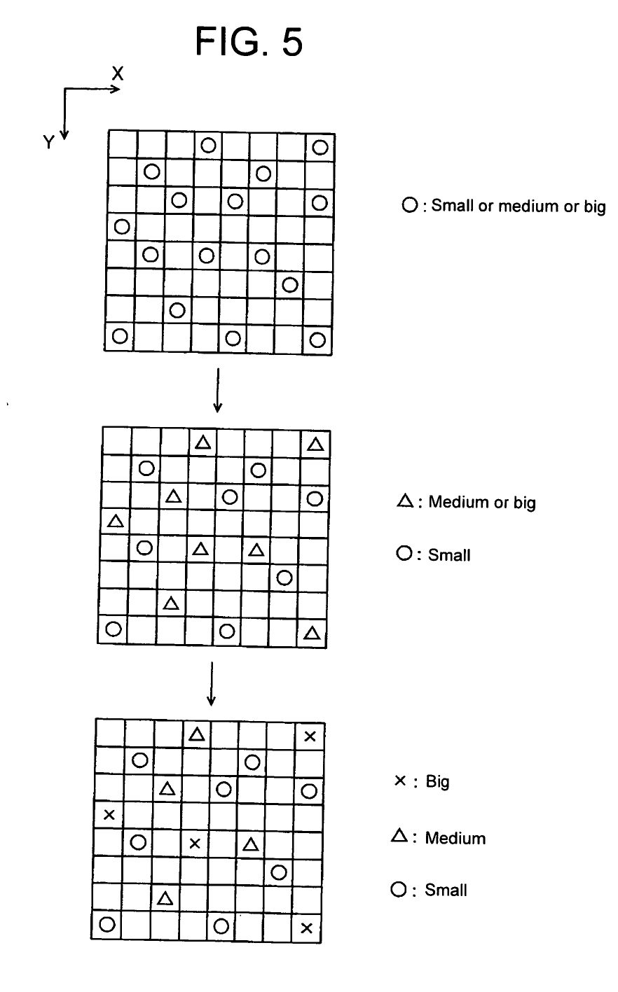

FIG. 5 is an explanatory drawing illustrating the above-mentioned processing. This drawing shows the way whether a dot is on or off is determined with respect to data equivalent to an 8 by 8 matrix of pixels. The upper part of the drawing shows an example of error diffusion processing performed at Step S200. A rectangle represents a pixel, and pixels for which it is determined by error diffusion that a dot is on are indicated by open circles. In the processing illustrated in FIG. 4, whether a small, medium, or big dot is on or off is determined on a pixel-by-pixel basis. In reality, therefore, whether a dot is on or off is determined with respect to some pixel, and then the processing is performed with respect to the next pixel. The figure shows the way whether small, medium, and big dots are on or off is determined with respect to multiple pixels for convenience of explanation.

In error diffusion processing, the disposition of dots is so determined that the dots will be disposed dispersedly as much as possible. As an example, it will be assumed that print operation is performed in a predetermined area with some gradation value (recording rate). In the result of error diffusion carried out in this case, the pixels at which a dot is on are dispersedly disposed in this area in a uniform fashion. Therefore, the highly dispersed disposition of entire small, medium, and big dots can be determined by giving priority to the combination of small, medium, and big dots when disposition is determined. When small, medium, and big dots are individually compared, it is found that the disposition of big dots is prone to have influence on graininess. In cases where differences in density between small, medium, and big dots are small, as mentioned above, how well the entire small, medium, and big dots are dispersed has the greatest influence on graininess. In this case, therefore, high dispersion can be ensured as a whole by giving priority to error diffusion for the combination of small, medium, and big dots.

After the disposition of dots is determined with respect to the combination of small, medium, and big dots at Step S200, the pixels at which either a medium dot or a big dot is on are determined with respect to the pixels marked with open circle at Step S220. In the middle part of FIG. 5, the pixels for which it is determined through the error diffusion processing at Step S220 that a dot is on are indicated by triangles. As mentioned above, setting a medium dot or a big dot to on is permitted only at pixels for which it is determined that the combination of small, medium, and big dots is on.

In the lower part of FIG. 5, the pixels for which it is determined through the error diffusion processing at Step S235 that a dot is on are indicated by x. Setting a big dot to on is permitted only at the pixels for which it has been determined that the combination of medium and big dots is on. As mentioned above, the pixels at which a medium dot or a big dot can be on are limited to those in the positions indicated by open circles in the upper part of FIG. 5. The disposition of the open circles is so determined that small, medium, and big dots will be disposed dispersedly as much as possible. Therefore, even when error diffusion processing is performed with the positions of medium and big dots limited, high dispersion can be ensured again with respect to the entire small, medium, and big dots.

(3) Other Embodiments:

In the above-mentioned embodiment, the combination of small, medium, and big dots is considered to have the greatest influence on graininess; therefore, the disposition of the small, medium, and big dots is preferentially determined. Needless to add, the order of processing may be changed according to the degree of influence on graininess.

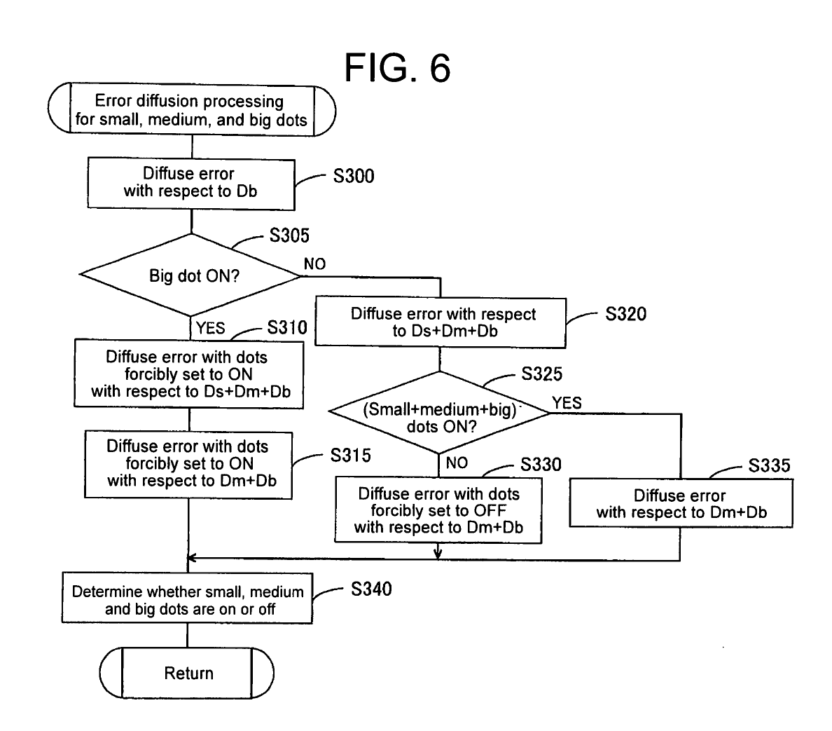

FIG. 6 is a flowchart illustrating processing performed in the following case: the disposition of only big dots has the greatest influence on graininess; a difference in density between small and medium dots is small; and graininess is more greatly influenced by the disposition of dots as the combination of small and medium dots than by singly recording small dots and medium dots, respectively. This embodiment adopts the following: the gradation values of only the big dots, as the gradation value data of recording rate data for determining the disposition of big dots; the sum (Ds+Dm+Db) of the gradation values of small, medium, and big dots as the gradation value data of total recording rate data for determining the disposition of dots with respect to the combination of small and medium dots; and the sum (Dm+Db) of the gradation values of medium and big dots as the gradation value data of total recording rate data for determining the disposition of medium dots.

In the processing illustrated in FIG. 6, first, error diffusion processing is performed with respect to the gradation values of big dots for determining the disposition of big dots (Step S300). Specifically, the following operation is performed: only Db is adopted as D in Expression (1) above; whether a dot is formed or not is determined with respect to Db of the pixel of interest; any error produced at this time is diffused into peripheral pixels that have not been subjected conversion; while this is being done, halftone processing that indicates whether dots are formed or not is generated; whether a big dot is on or off is determined based on the error (Th−D(X, Y)). After the disposition of big dots is determined at Step S300, processing is performed for determining the disposition of small and medium dots. At this time, a small dot or a medium dot cannot be simultaneously used at pixels at which a big dot is on. Therefore, the processing is branched depending on whether a big dot is on or not.

First, it is determined whether a big dot is on or not (Step S305). When a big dot is on, error diffusion processing is performed with respect to the above-mentioned Ds+Dm+Db and Dm+Db. This error diffusion with respect to Ds+Dm+Db and Dm+Db is processing for determining pixels at which any of small, medium, and big dots is on and pixels at which either a medium dot or a big dot is on, respectively. Therefore, when a big dot is on, it is forcibly determined also in these error diffusion processes that a big dot is on at the corresponding pixel.

More specific description will be given. When it is determined at Step S305 that a big dot is on, error diffusion processing is performed taking the following procedure: Ds+Dm+Db is taken as D in Expression (1) above; and it is forcibly determined that dots are on (Step S310). In the second term of Expression (1), processing is performed to subtract the absolute value of the error (Th−D(X, Y)) from D(X+1, Y). Here, both big dots and the combinations of small, medium, and big dots are on. As described later, ultimate determination is made at S340 with respect to the pixel of the coordinate variables X and Y so that any of small, medium, and big dots is on or all of them are off. Therefore, in the above-mentioned processing, it is determined that a big dot is on.

Further, error diffusion processing is performed taking the following procedure: Dm+Db is taken as D in Expression (1) above; and it is forcibly determined that dots are on (Step S315). Also, in this case, in the second term of Expression (1), processing is performed to subtract the absolute value of the error (Th−D(X, Y)) from D(X+1, Y).

When it is not determined at Step S305 that a big dot is on, error diffusion processing is performed with Ds+Dm+Db taken as D in Expression (1) above (Step S320). At this time, determination is made as follows: when the error (Th−D(X, Y)) is positive, it is determined that all of small, medium, and big dots are off; when the error is negative, it is determined that either a small dot or a medium dot is on. More specific description will be given. At Step S320, it can be determined that any of small, medium, and big dots is on. This processing is performed only when it was determined at Step S305 that a big dot was off. Therefore, when any of small, medium, and big dots is set to on in the error diffusion processing of Step s320, it can be determined that either a small dot or a medium dot is on.

Further, error diffusion is carried out to determine the disposition of medium dots with respect to the pixels that are set to on as the result of this error diffusion. For this purpose, it is determined whether a small, medium, or big dot has been set to on (whether a small dot or a medium dot is on) as the result of the error diffusion carried out at Step S320 (Step S325). When it is not determined at Step S325 that the combination of small, medium, and big dots has been set to on, none of small, medium, and big dots is disposed at the relevant pixel. Therefore, error diffusion processing is performed taking the following procedure: dots are forcibly set to off; Dm+Db that is a gradation value for determining the disposition of medium and big dots is taken as D in Expression (1) above; the absolute value of the error (Th−D(X, Y)) is added to D(X+1, Y) (Step S330).

When it is determined at Step S325 that a dot has been set to on with respect to the combination of small, medium, and big dots, error diffusion processing is further performed with Dm+Db that is a gradation value for determining the disposition of medium and big dots taken as D in Expression (1) above (Step S335). When the error (Th−D(X, Y)) is positive at this time, it is determined that medium and big dots are off. When this error is negative, the combination of medium and big dots is on. Since it is known as the result of determination at Step S305 that a big dot is off, however, it is determined that a medium dot is on.

The above processing is performed as follows: with respect to the combination of two or more kinds of dots, including the biggest dots, any error with respect to each pixel is diffused into peripheral pixels that have not been subjected to conversion according to total recording rate data that indicates the total of the recording rates of the dots that constitute the combination; whether a dot is formed or not is determined on a pixel-by-pixel basis only in positions other than the positions of the dots whose disposition has been determined; while this is being done, halftone data is generated. Thus, the disposition of each kind of dots is temporarily determined.

Based on the result of the above processing, whether small, medium, and big dots are on or off is determined (Step S340). More specific description will be given. When a big dot is on, it is determined that a big dot is on regardless of whether other dots are on or off. When a big dot is off and either a medium dot or a big dot is on, it is determined that a medium dot is on. When both a medium dot and a big dot are off at a pixel for which it has been determined that any of small, medium, and big dots is on, it is determined with respect to that pixel that a small dot is on. In the other cases, a dot is set to off.

Thus, halftone processing is performed with respect to dots that constitute a combination and whose disposition has not been determined, and the disposition of each kind of dots is determined.

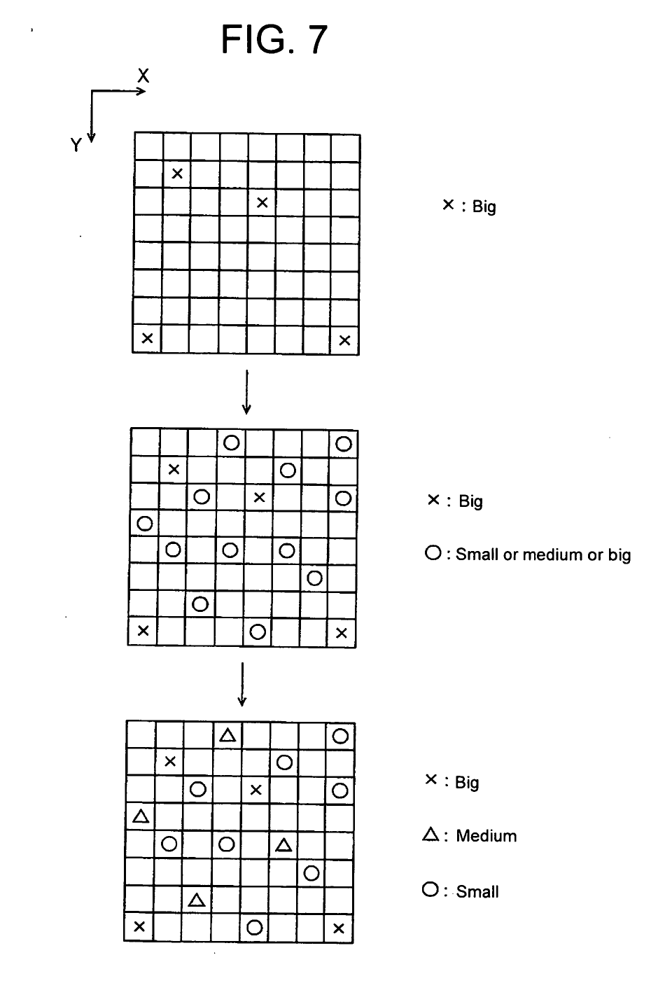

FIG. 7 is an explanatory drawing illustrating the above-mentioned processing. Similarly with FIG. 5, this drawing also shows the way whether a dot is on or off is determined with respect to data equivalent to an 8 by 8 matrix of pixel. The upper part of the drawing shows an example of error diffusion processing performed at Step S300. A rectangle represents a pixel, and pixels for which it is determined by error diffusion that a dot is on are indicated by x. In this embodiment, error diffusion is carried out first based on the gradation value Db of big dots. Therefore, high dispersion can be obtained with respect to the disposition of only big dots that will have the greatest influence on graininess in this embodiment.

After the disposition of big dots is determined at Step S300,. the disposition of dots is determined with respect to the combination of small, medium, and big dots at Steps S310 and S320. In the middle part of FIG. 7, the pixels for which it is determined through the error diffusion processing at Step S320 that a dot is on are indicated by open circles. At Step S310, it is determined that a dot is on also with respect to pixels for which it has been determined that a big dot is on. In the middle part of FIG. 7, the positions of these pixels are identical with the positions marked with x.

In the lower part of FIG. 7, the pixels for which it is determined through the error diffusion processing at Step S335 that a dot is on are indicated by triangles. At Step S315, it is determined that a dot is on also with respect to pixels for which it has been determined that a big dot is on. In the lower part of FIG. 7, the positions of these pixels are identical with the positions marked with x. As mentioned above, the positions of pixels at which a small dot or a medium dot is on are limited to the positions other than those marked with x in the upper part of FIG. 7. Since the disposition of big dots, marked with x, has the greatest influence on graininess, however, graininess can be reduced by determining the disposition of x first. Since a difference in density between small dots and medium dots is small, the positions of small dots and those of medium dots are simultaneously determined. Graininess can be more reduced as compared with cases where the disposition of only medium dots is selected first from the positions where a big dot is off.

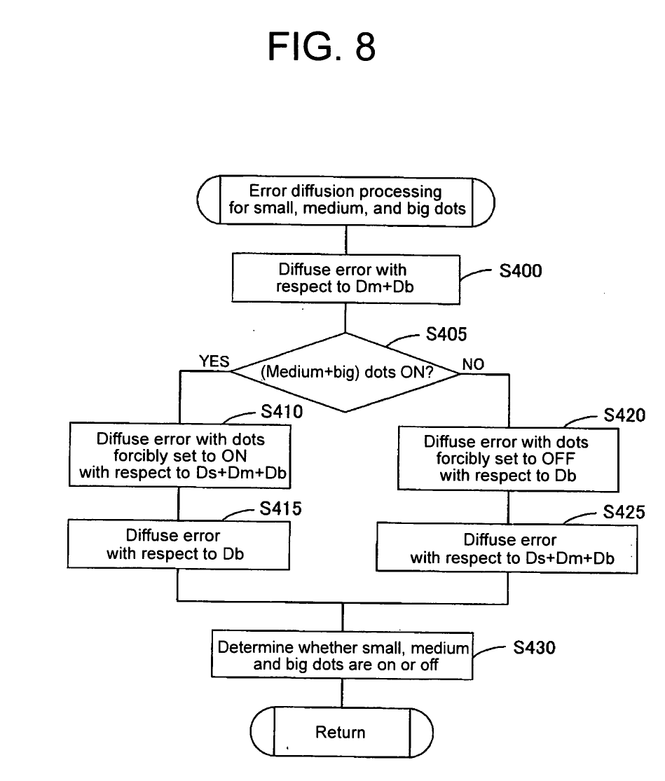

FIG. 8 is a flowchart illustrating processing performed in cases where the combination of medium and big dots has the greatest influence on graininess. This embodiments adopts the following: the sum (Dm+Db) of the gradation values of medium and big dots as the gradation value data of total recording rate data for determining the disposition of medium and big dots; the sum (Ds+Dm+Db) of the gradation values of small, medium, and big dots as the gradation value data of total recording rate data for determining the disposition of small dots; and the gradation value Db of big dots as the gradation value data of recording rate data for determining the disposition of big dots.

In the processing illustrated in FIG. 8, first, error diffusion processing is performed with respect to the sum (Dm+Db) of the gradation values of medium and big dots for determining the disposition of medium and big dots (Step S400). Specifically, the following operation is performed: Dm+Db is adopted as D in Expression (1) above, and whether medium and big dots are on or off based on the error (Th−D(X, Y)). After the disposition of medium and big dots is determined at Step S400, processing is performed for determining the disposition of small dots or medium dots. At this time, a small dot cannot be simultaneously used at pixels at which a medium dot or a big dot is on. Therefore, the processing is branched depending on whether a medium dot or a big dot is on or not.

First, it is determined whether a medium dot or a big dot is on or not (Step S405). When a medium dot or a big dot is on, error diffusion processing is performed taking the following procedure: Ds+Dm+Db is taken as D in Expression (1) above, and it is forcibly determined that a dot is on (Step S410) . At this time, in the second term of Expression (1), processing is performed to subtract the absolute value of the error (Th−D(X, Y)) from D(X+1, Y). Here, both the combination of medium and big dots and the combination of small, medium, and big dots are on. As described later, it is ultimately determined at S430 that a big dot is on. Further, error diffusion processing is performed with Db taken as D in Expression (1) above (Step S415). That is, when a big dot is on in the disposition of medium and big dots, it is set that a big dot is on.

When it is not determined at Step S405 that a big dot is on, error diffusion processing is performed taking the following procedure: Db is taken as D in Expression (1) above, and it is forcibly determined that a dot is off (Step S420). At this time, in the second term of Expression (1), processing is performed to add the absolute value of the error (Th−D(X, Y)) to D(X+1, Y). Further, error diffusion processing is performed with Ds+Dm+Db taken as D in Expression (1) above (Step S425). That is, processing is performed at pixels at which neither a medium dot nor a big dot is on in the disposition of medium and big dots for determining whether a small dot is on or not.

After the processing of Step S415 or Step S425, whether small, medium, and big dots are on or off is determined (Step S430). More specific description will be given. When a big dot is on, it is determined that a big dot is on regardless of whether other dots are on or off. When a big dot is off and either a medium dot or a big dot is on, it is determined that a medium dot is on. When both a medium dot and a big dot are off at a pixel for which it has been determined that any of small, medium, and big dots is on, it is determined with respect to that pixel that a small dot is on. In the other cases, a dot is set to off.

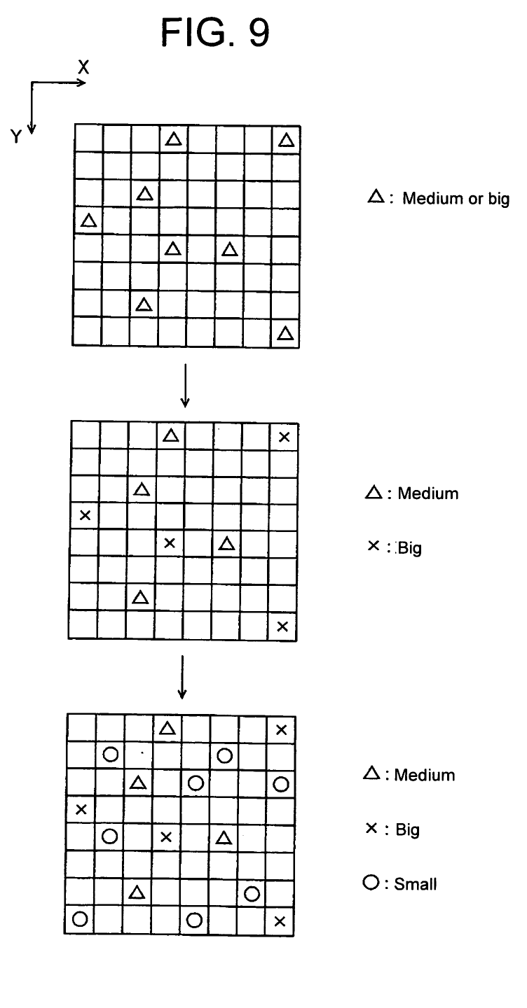

FIG. 9 is an explanatory drawing illustrating the above-mentioned processing. Similarly with FIG. 5, this drawing also shows the way whether a dot is on or off is determined with respect to data equivalent to an 8 by 8 matrix of pixels. The upper part of the drawing shows an example of error diffusion processing performed at Step S400. A rectangle represents a pixel, and pixels for which it is determined by error diffusion that a dot is on are indicated by triangles. In this embodiment, error diffusion is carried out first based on the gradation values Dm+Db of medium and big dots. Therefore, high dispersion can be ensured with respect to the disposition of the combination of medium and big dots that will have the greatest influence on graininess in this embodiment.

After the disposition of medium and big dots is determined at Step S400, the disposition of big dots is determined at Steps S415 and S420. In the middle part of FIG. 9, the pixels for which it is determined through the error diffusion processing at Step S410 that a dot is on are indicated by x. As a result, the dispositions of medium dots and big dots are determined. In the lower part of FIG. 9, the pixels for which it is determined through the error diffusion processing at Step S425 that a dot is on are indicated by open circles.

At Step S425, the pixels at which any of small, medium, and big dots is on are determined from among the pixels at which a medium dot and a big dot are off. Therefore, the pixels at which a small dot is on are eventually determined. As mentioned above, the positions of pixels at which a small dot is on are limited to the positions other than those marked with triangles, shown in the upper part of FIG. 9. Since the disposition of dots with respect to the combination of medium and big dots, indicated by triangles, has the greatest influence on graininess, however, graininess can be reduced by determining the disposition of triangles first.

As mentioned above, according to the invention, the disposition of dots is determined as follows: disposition is determined with respect to one kind of dots or a combination of dots that will have the greatest influence on graininess, of N kinds of dots or combinations of n kinds (n is an integer not less than 2 and not more than N) of dots; thereafter, disposition is determined with respect to dots whose disposition has not been determined yet. As a result, it is possible to dispose a kind of dots or a combination of dots that will be prone to have influence on graininess so that graininess will be suppressed. In the above-mentioned embodiments, dispositions are determined in descending order of influence on graininess. In terms of graininess suppression, there are cases where graininess can be sufficiently suppressed just by determining first the disposition of dots or a combination of dots that will have the greatest influence on graininess. In these cases, the following construction may be adopted: the invention is applied only to a kind of dots or a combination of dots whose disposition is determined first; and the disposition of dots are determined in predetermined order with respect to the other kinds of dots or the other combinations of dots.

In the above-mentioned embodiments, influence on graininess is considered with respect to recording material in every color. Needless to add, the following construction may be adopted: the invention is applied only to a specific ink (e.g. only K, only C, M, and Y) that will have great influence on graininess.

With respect to N kinds of dots, different in color material quantity per dot, the above-mentioned embodiments are based on the assumption that the discharge quantity per dot differs. Instead, the invention may be applied to cases where the discharge quantity per dot is substantially identical and the density itself of ink differs. For example, the invention is applied to the following printers: printers that use inks whose densities per unit quantity are different because the color material quantity in solvent differs, for example, printers that use C and lc inks, M and lm inks, and K and lk (light black) inks. The printer used in the above embodiments is a printing device so designed as to form on printing media the N kinds of dots, identical in size per dot, using inks identical in hue and different from each other in the density of color material. The printing control device according to the invention operates as follows: first, with respect to a combination of two or more kinds of dots, including the kind of dots highest in the density of color material, of N kinds of dots, it performs halftone processing. The control device performs this halftone processing as follows: it determines whether a dot is formed or not with respect to each pixel according to total recording rate data that indicates the total of recording rates of the dots that constitute the combination on a pixel-by-pixel basis. It adds any error produced at this time to peripheral pixels that have not been subjected to conversion yet. While doing this, it generates halftone data that indicates whether a dot is formed or not on a pixel-by-pixel basis. It temporarily determines the disposition of dots by performing the above halftone processing. Next, the printing control device performs the following halftone processing with respect to the dots that constitute the above combination and whose disposition has not been determined yet: it determines whether a dot is formed or not on a pixel-by-pixel basis only in the positions of the combination of dots temporarily determined by adding the error with respect to each pixel to peripheral pixels that have not been subjected to conversion yet according to recording rate data that indicates the recording rate of that kind of dots. While doing this, it generates halftone data that indicates whether a dot is formed or not on a pixel-by-pixel basis. It determines the disposition of dots by performing the above halftone processing.

As mentioned above, with respect to printers that use deep and pale inks, it is desirable that deep and pale inks should not be recorded at a pixel in the same position. To dispose dots of deep and pale inks so that they will not be recorded in the same position, the following measure is taken: the dispositions of combinations of deep and pale inks or of deep and pale inks are determined in descending order of influence on graininess again. Thus, graininess can be suppressed.

While the invention has been particularly shown and described with respect to preferred embodiments thereof, it should be understood by those skilled in the art that the foregoing and other changes in form and detail may be made therein without departing from the sprit and scope of the invention as defined in the appended claims.

What is claimed is:

1. A printing control method for controlling a printing device capable of recording N kinds (N is an integer not less than 2) of dots, different in color material quantity per dot, the method comprising:
determining disposition of one kind of dots or a combination of two or more kinds of dots that will have the greatest influence on graininess, among the N kinds of dots and the combinations of n kinds (n is an integer not less than 2 and not more than N) of dots, and thereafter, determining disposition of the dots whose disposition has not been determined yet when the disposition of dots is determined based on image data that indicates the recording density of each pixel; and
carrying out control so as to print an image based on the determined disposition of dots.

2. The printing control method according to claim 1, comprising:
determining disposition with respect to one kind of dots or a combination of two or more kinds of dots of the N kinds of dots or the combinations of n kinds of dots in descending order of influence on graininess.

3. The printing control method according to the claim 1, comprising:
determining beforehand the degree of influence on graininess according to a difference in color material quantity between dots combined from among the N kinds of dots;
determining the order of determining disposition with respect to the N kinds of dots and the combinations of n kinds of dots according to the degree of influence; and
determining disposition with respect to one kind of dots or a combination of two or more kinds of dots in the determined order.

4. The printing control method according to claim 1, comprising:
temporarily determining the disposition of a combination of two or more kinds of dots of the N kinds of dots in a lump; and
determining the disposition of a single kind of dots that constitute the combination and whose disposition has not been determined yet only in the positions of the combination of dots temporarily determined.

5. The printing control method according to claim 1, wherein the printing device is a device so designed as to form on printing media the N kinds of dots, different from each other in size per dot, using inks identical in the density of contained color material, the printing control method comprising:
generating recording rate data that indicates the recording rate of each kind of dots of the N kinds of dots on a pixel-by-pixel basis based on the image data;
performing halftone processing with respect to a combination of two or more kinds of dots, including the biggest dot of the N kinds of dots, in which halftone processing: whether a dot is formed or not is determined with respect to each pixel according to total recording rate data that indicates the total of the recording rates of the dots that constitute the combination on a pixel-by-pixel basis; any error produced at this time is added to peripheral pixels that have not been subjected to conversion yet; while this is being done, halftone data that indicates whether a dot is formed or not on a pixel-by-pixel basis is generated, and thereby temporarily determining disposition; and
performing halftone processing with respect to the dots that constitute the combination and whose disposition has not been determined yet, in which halftone processing: whether a dot is formed or not is determined with respect to each pixel only in the positions of the combination of dots temporarily determined by adding the error with respect to each pixel to peripheral pixels that have not been subjected to conversion yet according to recording rate data that indicates the recording rates of the dots; while this is being done, halftone data that indicates whether a dot is formed or not on a pixel-by-pixel basis is generated, and thereby determining disposition.

6. The printing control method according to claim 1, wherein the printing device is a device so designed as to form on printing media the N kinds of dots, different from each other in size per dot, using inks identical in the density of contained color material, the printing control method comprising:
generating recording rate data that indicates the recording rate of each kind of dots of the N kinds of dots on a pixel-by-pixel basis based on the image data;
performing halftone processing only with respect to the biggest dots of the N kinds of dots, in which halftone processing: whether a dot is formed or not is determined with respect to each pixel according to recording rate data that indicates the recording rate of the dots; any error produced at this time is added to peripheral pixels that have not been subjected to conversion yet; while this is being done, halftone data that indicates whether a dot is formed or not on a pixel-by-pixel basis, and thereby determining disposition;
performing halftone processing with respect to a combination of two or more kinds of dots, including the biggest dot, of the N kinds of dots, in which halftone processing: any error with respect to each pixel is added to peripheral pixels that have not been subjected to conversion yet according to total recording rate data that indicates the total of the recording rates of the dots that constitute the combination on a pixel-by-pixel basis; whether a dot is formed or not is determined with respect to each pixel only in the positions other than the positions of dots determined as mentioned above; while this is being done, halftone data that indicates whether a dot is formed or not on a pixel-by-pixel basis is generated, and thereby temporarily determining disposition; and
performing halftone processing with respect to the dots that constitute the combination and whose disposition has not been determined yet, in which halftone processing: any error with respect to each pixel is added to peripheral pixels that have not been subjected to conversion yet according to recording rate data that indicates the recording rates of the dots; whether a dot is formed or not is determined with respect to each pixel only in the positions of the combination of dots temporarily determined as mentioned above; while this is being done, halftone data that indicates whether a dot is formed or not on a pixel-by-pixel basis is generated, and thereby determining disposition.

7. The printing control method according to claim 1, wherein the printing device is a device so designed as to form on printing media the N kinds of dots, identical in size per dot, using inks identical in hue and different from each other in the density of color material, the printing control method comprising:
performing halftone processing with respect to a combination of two or more kinds of dots, including the dots highest in the density of color material, of the N kinds of dots, in which halftone processing: whether a dot is formed or not is determined with respect to each pixel according to total recording rate data that indicates the total of the recording rates of the dots that constitute the combination on a pixel-by-pixel basis; any error produced at this time is added to peripheral pixels that have not been subjected to conversion yet; while this is being done, halftone data that indicates whether a dot is formed or not on a pixel-by-pixel basis is generated, and thereby temporarily determining disposition; and
performing halftone processing with respect to the dots that constitute the combination and whose disposition has not been determined yet, in which halftone processing: any error with respect to each pixel is added to peripheral pixels that have not been subjected to conversion yet according to recording rate data that indicates the recording rates of the dots; whether a dot is formed or not is determined with respect to each pixel only in the positions of the combination of dots temporarily determined as mentioned above; while this is being done, halftone data that indicates whether a dot is formed or not on a pixel-by-pixel basis is generated, and thereby determining disposition.

8. A printing control method for controlling a printing device capable of recording N kinds (N is an integer not less than 2) of dots different in color material quantity per dot, the method comprising:
determining disposition of a combination of two or more kinds of dots in a lump, and thereafter, determining disposition of dots whose disposition has not been determined yet when the disposition of dots is determined based on image data that indicates the recording density of each pixel; and
carrying out control so as to print an image based on the determined disposition of dots.

9. A printing control device that controls a printing device capable of recording N kinds (N is an integer not less than 2) of dots different in color material quantity per dot, the printing control device comprising:
a halftone processing unit that, when disposition of dots is determined based on image data that indicates the recording density of each pixel, determines disposition of one kind of dots or a combination of two or more kinds of dots that will have the greatest influence on graininess, among the N kinds of dots and the combinations of n kinds (n is an integer not less than 2 and not more than N) of dots, and thereafter determines disposition of the dots whose disposition has not been determined yet; and
a printing control unit that carries out control so as to print an image based on the determined disposition of dots.

10. Media with a printing control program recorded thereon for causing a computer to carry out the function of controlling a printing device capable of recording N kinds (N is an integer not less than 2) of dots different in color material quantity per dot, the printing control program causing a computer to carry out:
a halftone processing function of, when disposition of dots is determined based on image data that indicates the recording density of each pixel, determining disposition with respect to one kind of dots or a combination of two or more kinds of dots that will have the greatest influence on graininess among the N kinds of dots and the combinations of n kinds (n is an integer not less than 2 and not more than N) of dots, and thereafter determining disposition with respect to dots whose disposition has not been determined yet; and
a printing control function of carrying out control so as to print an image based on the determined disposition of dots.
